(19) United States
(12) Patent Application Publication
(10) Pub. No.: US 2024/0403712 A1
(43) Pub. Date: Dec. 5, 2024

(54) INFORMATION PROCESSING APPARATUS, INFORMATION PROCESSING METHOD, AND NON-TRANSITORY COMPUTER READABLE MEDIUM

(71) Applicant: Canon Medical Systems Corporation, Otawara-shi (JP)

(72) Inventors: Kosuke ARITA, Nasushiobara (JP); Sho SASAKI, Utsunomiya (JP)

(73) Assignee: Canon Medical Systems Corporation, Otawara-shi (JP)

(21) Appl. No.: 18/678,115

(22) Filed: May 30, 2024

(30) Foreign Application Priority Data
May 30, 2023 (JP) 2023-088816

(51) Int. Cl. G06N 20/00

(52) U.S. Cl. CPC G06N 20/00

(57) ABSTRACT

According to one embodiment, an information processing apparatus for applying to an artificial intelligence (AI) model, includes processing circuitry. The processing circuitry is configured to acquire a first data set having a first data trend and a second data set having a second data trend different from the first data trend, the first data set and the second data set being input to the AI model and discriminated by the AI model. The processing circuitry is configured to calculate a first feature vector based on the first data set and a second feature vector based on the second data set. The processing circuitry is configured to generate augmented data having the second data trend based on the first feature vector and the second feature vector.

### CROSS-REFERENCE TO RELATED APPLICATION

This application is based upon and claims the benefit of priority from Japanese Patent Application No. 2023-088816, filed May 30, 2023, the entire contents of which are incorporated herein by reference.

### FIELD

Embodiments described herein relate generally to an information processing apparatus, an information processing method, and a non-transitory computer readable medium.

### BACKGROUND

As medical AI has progressed in recent years, a clinical decision support (CDS) system using a CDS model learned by machine learning has been utilized. However, in clinical sites, a data trend based on patient information may change from a data trend of a data group that was utilized when a CDS model was trained. Such a change is called a “drift”. The drift may deteriorate the performance of the CDS model. If it is found that a drift has occurred, an immediate corrective measure is desirable.

As a model management method in case of occurrence of a drift, a method is known in which retraining is performed using a model having a data distribution similar to a data distribution of a new drift data set. Alternatively, a counterfactual thinking sample generation method is known as a method for generating versatile data.

However, if these methods are employed in an early stage of the occurrence of a drift, a decision boundary to be constructed will be indefinite due to the small number of data pieces of the drift data set. That is, the accuracy of generated data may be low, for example, a drift data set including a drift that cannot occur in the future may be generated. As a result, there is a problem in which a CDS model that cannot correctly estimate actual patient data may be generated.

### BRIEF DESCRIPTION OF THE DRAWINGS

FIG. 1 is a block diagram showing an information processing system including an information processing apparatus according to an embodiment.

FIG. 2 is a flowchart showing an operation of the information processing apparatus according to the embodiment.

FIG. 3 is a diagram showing specific examples of a drift data set and a non-drift data set according to the embodiment.

FIG. 4 is a diagram showing an example of a decision boundary according to the embodiment.

FIG. 5 is a diagram showing an example of feature vectors of the drift data set and the non-drift data set according to the embodiment.

FIG. 6 is a diagram showing an example of generation of pieces of drift candidate data according to the embodiment.

FIG. 7 is a diagram showing a concept of processing for generating augmented data from the drift candidate data according to the embodiment.

FIG. 8 is a diagram showing an example of a distribution of generated augmented data according to the embodiment.

FIG. 9 is a diagram showing an example of a screen display according to the embodiment.

### DETAILED DESCRIPTION

In general, according to one embodiment, an information processing apparatus for applying to an artificial intelligence (AI) model, includes processing circuitry. The processing circuitry is configured to acquire a first data set having a first data trend and a second data set having a second data trend different from the first data trend, the first data set and the second data set being input to the AI model and discriminated by the AI model. The processing circuitry is configured to calculate a first feature vector based on the first data set and a second feature vector based on the second data set. The processing circuitry is configured to generate augmented data having the second data trend based on the first feature vector and the second feature vector. Hereinafter, an information processing apparatus, an information processing method, and an information processing program according to an embodiment will be described with reference to the drawings. In the embodiment described below, elements assigned with the same reference symbols are assumed to perform the same operations, and redundant descriptions thereof will be omitted as appropriate. Hereinafter, an embodiment will be described with reference to the accompanying drawings.

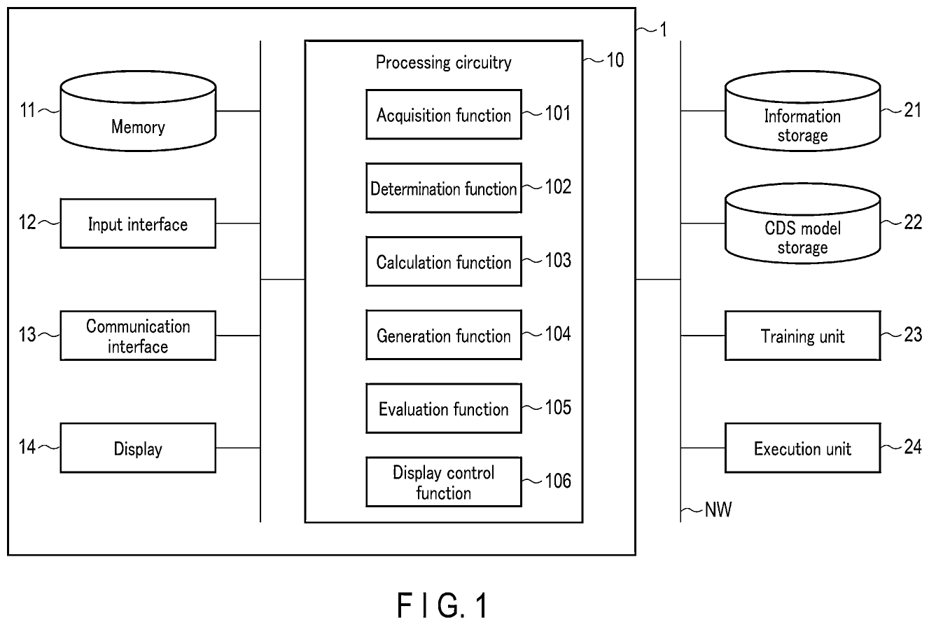

An information processing system including an information processing apparatus according to the embodiment will be described with reference to the block diagram of FIG. 1.

The information processing system of the embodiment includes an information processing apparatus 1, a patient information storage 21, a CDS model storage 22, a training unit 23, and an execution unit 24, which are connected via a network NW. The network NW is assumed to be an in-hospital network; however, the components (the information processing apparatus 1, the patient information storage 21, the CDS model storage 22, the training unit 23, and the execution unit 24) may be connected via an external network, as long as the concealment of data is ensured by using a virtual private network (VPN), or the like.

The patient information storage 21 stores patient information of each patient. The patient information includes information to identify a patient, such as a patient ID, a patient name, a gender, an age, and the like, and information on medical care of the patient, such as a preexisting disorder, observation information, disease name information, details of treatment, a clinical pass, and the like.

The clinical decision support (CDS) model storage 22 stores a trained model generated by training a machine learning model by means of the training unit 23 using the patient information, and the like. In the following, a CDS model to support decision-making is described as an example of the trained model; however, the trained model may be a model for another use, such as an image diagnosis, a prognostication, and the like.

The training unit 23 trains a machine learning model, such as a neural network, and generates a CDS model. The training unit 23 retrains the CDS model, and generates an updated CDS model which is a retrained model. The machine learning model can be trained using a general machine learning method, such as supervised learning; therefore, detailed explanations thereof will be omitted.

The execution unit 24 executes inference using the CDS model for newly acquired patient information. The execution unit 24 also executes inference using the updated CDS model for the newly acquired patient information.

The information processing apparatus 1 includes processing circuitry 10, a memory 11, an input interface 12, a communication interface 13, and a display 14, which are connected via a bus or a network.

The processing circuitry 10 includes processors such as a central processing unit (CPU), a graphics processing unit (GPU), or the like, as hardware resources. For example, the processing circuitry 10 realizes an acquisition function 101, a determination function 102, a calculation function 103, a generation function 104, an evaluation function 105, and a display control function 106 by executing various programs.

The training unit 23 and the execution unit 24 may be incorporated into the information processing apparatus 1 as functions of the processing circuitry.

The acquisition function 101 acquires a first data set having a first data trend, and a second data set having a second data trend different from the first data trend. Hereinafter, a non-drift data set in which a drift of patient information has not occurred will be explained as an example of the first data set. A drift data set in which a drift of patient information has occurred will be explained as an example of the second data set.

The determination function 102 determines a decision boundary that classifies a non-drift data set and a drift data set.

The calculation function 103 calculates a first feature vector based on the non-drift data set and a second feature vector based on the drift data set.

The generation function 104 generates one or more pieces of candidate data which are candidates to belong to the second data set (hereinafter referred to as drift candidate data), and augmented data having a first data trend from among the one or more pieces of candidate data based on the first feature vector and the second feature vector.

The evaluation function 105 evaluates, using the second data set and the augmented data, whether retraining of the trained model trained by the first data set is necessary or not.

The display control function 106 performs control of displaying various data and a graphical user interface (GUI) on the display 14. For example, the display control function 106 displays, on the display 14, a graph relating to the drift data set, the augmented data, and the feature vectors, and a graph relating to a performance evaluation of the CDS model.

The memory 11 is a storage device, such as a hard disk drive (HDD), a solid state drive (SSD), or an integrated circuit storage device, adapted to store various information items, such as the non-drift data set, the drift data set, the feature vectors, the candidate data, the augmented data, and the like, as will be described later. The memory 11 may also be a drive apparatus or the like that reads and writes various information items from and to a portable storage medium, such as a CD-ROM drive, a DVD drive, a flash memory, and the like. For example, the memory 11 stores medical data collected in the past, a control program, and the like.

The input interface 12 includes an input apparatus that receives various commands from the user. Examples of the input apparatus that can be used include a keyboard, a mouse, various switches, a touch screen, a touch pad, and the like. It should be noted that the input apparatus is not limited to those having physical operation parts such as the mouse and the keyboard. For example, examples of the input interface 12 also include electrical signal processing circuitry that receives an electrical signal corresponding to an input operation from an external input apparatus provided separately from a magnetic resonance imaging apparatus 20, and outputs the received electrical signal to various types of circuitry. The input interface 12 may also be a speech recognition apparatus that converts a speech signal collected by a microphone to an instruction signal.

The communication interface 13 is an interface connecting, via a local area network (LAN), a workstation, a picture archiving and communication system (PACS), a hospital information system (HIS), a medical image diagnosis apparatus such as a radiology information system (RIS), an X-ray computed tomography (CT) device, a magnetic resonance imaging (MRI) apparatus, and the like. The communication interface 13 transmits and receives various information items to and from the connected workstation, PACS, HIS and RIS.

The display 14 displays various information items. As the display 14, for example, a CRT display, a liquid crystal display, an organic EL display, an LED display, a plasma display, or any other display known in the relevant technical field may be used as appropriate.

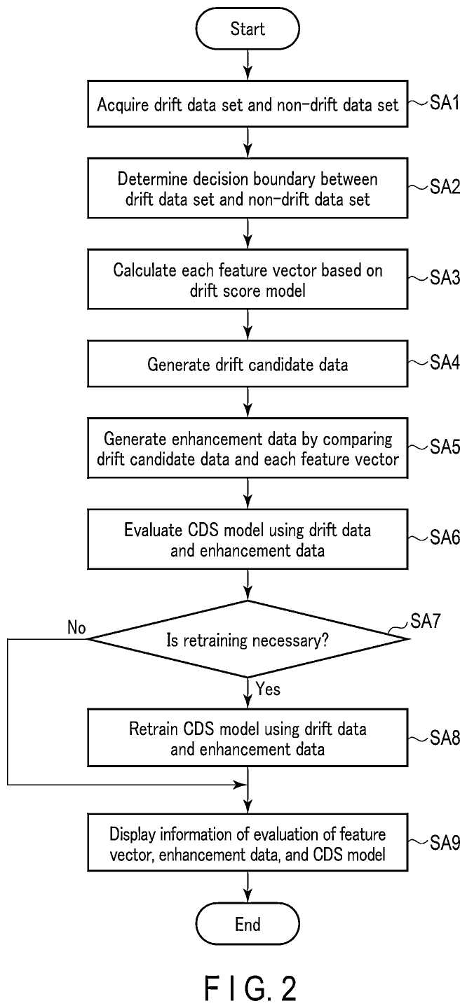

Next, an operation example of the information processing apparatus 1 according to the present embodiment will be described with reference to the flowchart of FIG. 2.

In step SA1, the processing circuitry 10 acquires a drift data set and a non-drift data set relating to the patient information by means of the acquisition function 101. In the present embodiment, it is assumed that a label indicative of the drift data or the non-drift data has been assigned to each piece of patient information in advance.

In step SA2, the processing circuitry 10 determines the decision boundary between the drift data set and the non-drift data set by means of the determination function 102.

In step SA3, the processing circuitry 10 calculates, by means of the calculation function 103, a feature vector indicating a drift data set trend based on a feature amount, for each of the drift data set and the non-drift data set based on a drift score model. For example, a feature vector is calculated based on a drift score indicating to what degree the drift data set having a feature amount of 1 or more is deviated from the non-drift data set having the same feature amount. Calculation of a feature vector will be described later with reference to FIG. 5.

In step SA4, the processing circuitry 10 generates one or more pieces of drift candidate data based on the non-drift data set by means of the generation function 104. The drift candidate data is data that is to be a candidate to belong to the drift data set.

In step SA5, the processing circuitry 10 generates augmented data based on each piece of drift candidate data and each feature vector by means of the generation function 104. The augmented data is data that belongs to a data trend of the drift data set and differs from the data trend of the non-drift data set. This is because data adaptable to the data trend of the actual drift data set can be generated by selecting such a data trend, so that the augmented data may be adaptable to the actual drift data set or may not maintain the data trend of the non-drift data set, since the decision boundary determined on the basis of a drift data set including a small number of pieces of data is an indefinite boundary.

In step SA6, the processing circuitry 10 evaluates, by means of the evaluation function 105, a performance of the CDS model, which is a trained model trained with the non-drift data set using the generated augmented data and the drift data set. Specifically, the processing circuitry 10 may cause the evaluation function 105 to execute inference by the execution unit 24 and input the augmented data or the drift data set to the trained model, thereby confirming whether a desired inference accuracy can be obtained or not.

In step SA7, the processing circuitry 10 determines, by means of the evaluation function 105, whether retraining of the CDS model is necessary or not. If a desired inference result is not obtained by the process of step SA6, for example if the inference accuracy is lower than a threshold value, it is determined that retraining is necessary and the flow proceeds to step SA8. On the other hand, if a desired inference result is obtained, for example if the inference accuracy is equal to or higher than the threshold value, it is determined that retraining is unnecessary and the flow proceeds to step SA9.

In step SA8, by means of the evaluation function 105, the processing circuitry 10 sends an instruction to the training unit 23, thereby executing retraining of the CDS model using the drift data set and the augmented data, and generating a retrained CDS mode, in other words, an updated CDS model.

In step SA9, the processing circuitry 10 displays, by means of the display control function 106, an index or the like relating to a performance evaluation of the CDS model. Specifically, detailed explanations will be provided later with reference to FIG. 9.

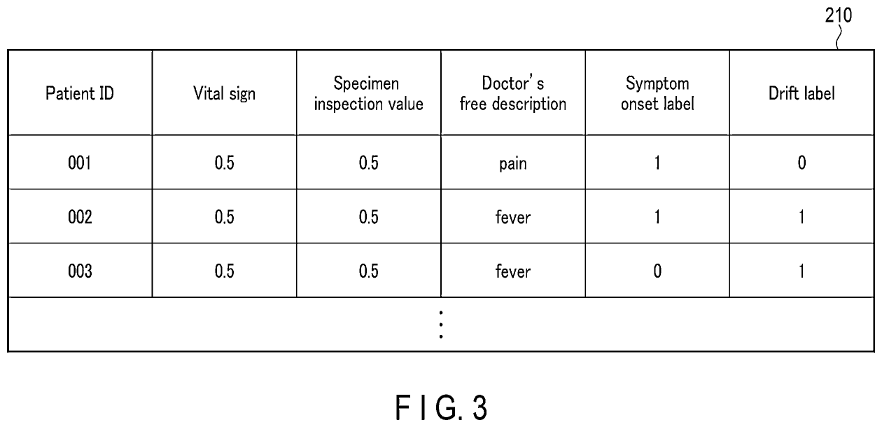

Next, specific examples of the drift data set and the non-drift data set will be described with reference to FIG. 3.

FIG. 3 shows a table 210 indicating patient information stored in the patient information storage 21. In the table, a patient ID, a vital sign, a specimen inspection value, a doctor's free description, a symptom onset label, and a drift label are associated with each other and stored as one data item. The drift label is indispensable, but any other items of information may be associated with the patient ID. In the example of FIG. 3, the specimen inspection value and the vital sign included in the patient information, a feature amount calculated from a medical image, or the like serves as a feature amount of the patient information. In this example, the vital sign, the specimen inspection value, or the doctor's free description corresponds to the feature amount. The symptom onset label is, for example, a value indicating negative or positive, and serves as a correct answer label with respect to the patient information. The drift label is a label indicating whether the present data item has a trend deviating from the data trend of the past patient information, that is, whether the data item is a drift data set. The drift label is indicated as “1” if the data is drift data, and “0” if the data is non-drift data. The drift label is not limited to “1” or “0”, but may be distinguished by any other symbol or character string. It is assumed that whether each data item of the patient information is drift data or non-drift data has been labeled in advance. For example, the following data can be labeled as non-drift data: data that was used in model learning of the CDS model, data that was not alerted as drift data by a drift detecting function of all data acquired when operating the CDS model, and data that the doctor determined as not having caused a drift. On the other hand, for example, the following data can be labeled as drift data: data that was alerted as drift data by the drift detecting function of all data acquired when operating the CDS model, and data that the doctor determined as having caused a drift.

The drift detecting function may be performed by, for example, monitoring a change in data distribution of patient information, and obtaining a degree of deviation of a data distribution of the patient information obtained at a time of inference from a data distribution at a time of training of the CDS model, using a function, such as a Wasserstein distance, a Kolmogorov-Smirnov test, a Eucledian distance, a chi-square statistic, or the like. If an output from the function is equal to or larger than a threshold value, the patient information obtained at the time of inference can be determined as being deviated from the data at the time of training and therefore determined as a drift data set. In the example of FIG. 3, since the drift label of the patient ID “001” is “0”, it is understood that the data item of the patient is non-drift data. On the other hand, since the drift label of the patient IDs “002” and “003” is “1”, it is understood that these data items are drift data.

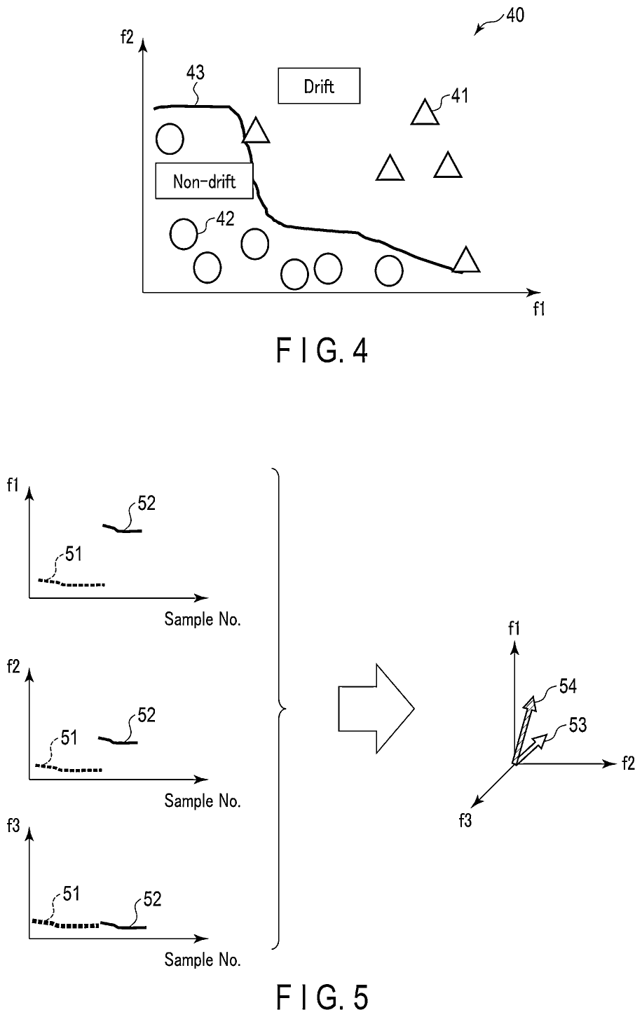

Next, an example of the decision boundary according to the embodiment will be described with reference to FIG. 4.

FIG. 4 is a plot diagram 40 showing a distribution of patient information in a two-dimensional feature amount space in which horizontal and vertical axes represent two types of feature amounts included in the patient information (denoted as f1 and f2 in the diagram). The processing circuitry 10 determines, by means of the determination function 102, the decision boundary which serves as a boundary when the drift data set and the non-drift data set are classified based on the drift labels of the patient information. The method for determining a decision boundary may be a general method for determining a decision boundary using, for example, a support vector machine (SVM) or a neural network, and detailed explanations thereof are omitted.

Specifically, in the example of FIG. 4, the patient information is plotted in the two-dimensional feature amount space in which the horizontal axis represents a feature amount f1 and the vertical axis represents a feature amount f2. In the plot diagram 40, pieces of drift data 41 of the patient information are plotted as circles, and form a drift data set. Similarly, in the plot diagram 40, pieces of non-drift data 42 of the patient information are plotted as triangles, and form a non-drift data set. As shown in FIG. 4, the data distributions of the drift data set and the non-drift data set are deviated. Therefore, a decision boundary 43 that classifies the drift data set and the non-drift data set is determined on the two-dimensional feature amount space.

In this embodiment, it is assumed that the drift data set includes fewer pieces of data than the non-drift data set in the process of the present embodiment; therefore, the decision boundary determined based on the fewer pieces of drift data may be low in accuracy. Furthermore, for convenience of explanation, the plot diagram 40 shows an example in which the decision boundary of the two types of feature amounts is determined. Actually, however, the patient information may contain three or more types of feature amounts. Even in the case where the patient information contains three or more types of feature amounts, a decision boundary may be determined by a general method for determining a decision boundary using an SVM, a neural network, or the like.

Next, an example of feature vectors of the drift data set and the non-drift data set will be described with reference to FIG. 5.

A left part of FIG. 5 is a graph showing a change in each of feature amounts f1 to f3 in the patient information. The horizontal axis represents a sample number of the patient information, that is, for example, data items shown in FIG. 3 arranged in time series, whereas the vertical axis represents a drift score of the feature amount. In the graph, values of a non-drift data set 51 and values of a drift data set 52 are respectively plotted.

The drift score may be calculated by using a drift score model calculated from the non-drift data set 51. A restriction that is independent of the number of samples of pieces of data of the drift data set 52 can be calculated by using the feature of the non-drift data set 51. For example, by means of the calculation function 103, the processing circuitry 10 may extract a correlation among the feature amounts of the non-drift data set 51, and may construct a drift score model based on a Gaussian graphical model or a structural equation model representing the correlation among the feature amounts. For example, the correlation that the feature amount f2 is 0.4 times the feature amount f1 and the feature amount f3 is 0.6 times the feature amount f1 can be constructed as a drift score model.

By means of the calculation function 103, the processing circuitry 10 applies the drift score model to each of the non-drift data set 51 and the drift data set 52, and calculates a drift score for each feature amount. In the example shown in the left part of FIG. 5, the drift scores of the feature amount f1 and the feature amount f2 of the non-drift data set 51 are deviated from those of the drift data set 52. On the other hand, the drift score of the feature amount f3 of the non-drift data set 51 and that of the drift data set 52 are of substantially the same value.

Next, as shown in a right part of FIG. 5, the processing circuitry 10 calculates, by means of the calculation function 103, an average value of the drift scores of the respective pieces of the non-drift data for each feature amount regarding the non-drift data set 51, and calculates a feature vector 53 on a feature amount space in which one feature amount is represented on one axis. Similarly, the processing circuitry 10 calculates an average value of the drift scores of the respective pieces of the drift data for each feature amount regarding the drift data set 52, and calculates a feature vector 54 on a multidimensional feature amount space in which one feature amount is represented on one axis. In the example shown in the right part of FIG. 5, the feature vector 53 based on the non-drift data set 51 and the feature vector 54 based on the drift data set 52 are represented in the feature amount space. From the comparison between the feature vector 53 and the feature vector 54, it is understood that there is no difference between the vectors in drift score of the feature amount f3, but the drift score in the feature amount f1 of the drift data set is larger than that of the non-drift data set.

A feature vector may be calculated not only based on an average value of drift scores, but also based on another statistical value, such as a central value.

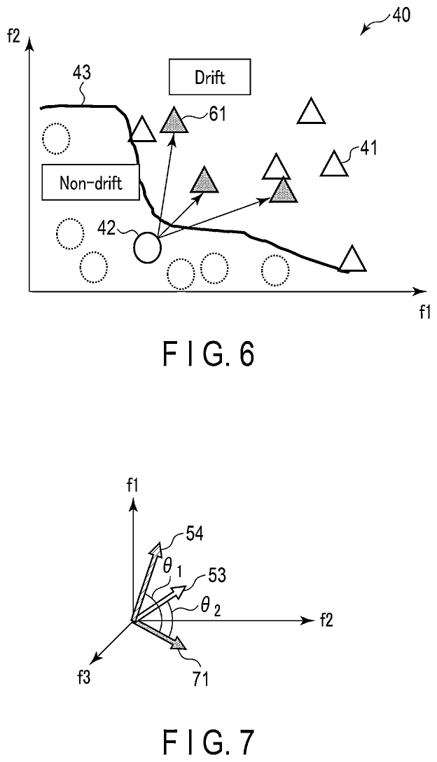

Next, an example of generation of drift candidate data according to the present embodiment will be described with reference to FIG. 6.

In an example of FIG. 6, similarly to the example of FIG. 4, a non-drift data set and a drift data set are indicated in a two-dimensional feature amount space in which the horizontal axis represents a feature amount f1 and the vertical axis represents a feature amount f2.

The processing circuitry 10 generates, by means of the generation function 104, one or more pieces of drift candidate data 61 from a piece of non-drift data 42. The drift candidate data 61 may be generated by a known method using, for example, a neural network, an SVM, reinforcement learning, a genetic algorithm, or the like. In the present embodiment, one or more pieces of drift candidate data 61 can be generated by varying feature amounts of patient information, which is the non-drift data 42.

As conditions for generating drift candidate data, the following two conditions are set.

A first condition is to generate drift candidate data, which belongs to the drift data set, from the non-drift data 42 over the decision boundary 43. This is for the purpose of increasing the reality and the certainty of data by generating a drift data set based on the non-drift data set including a large number of samples. To meet the first condition, it suffices that the processing circuitry 10 generates, by means of the generation function 104, drift candidate data 61 in which a loss is equal to or smaller than a threshold value using, for example, a hinge loss as a loss function.

A second condition is that when generating a plurality of pieces of drift candidate data 61, the generated pieces of drift candidate data 61 have variety. This is because data having variety is more practically useful in a case of reinforcing a plurality of pieces of drift data. To meet the second condition, it suffices that the processing circuitry 10 generates, by means of the generation function 104, a plurality of pieces of drift candidate data 61 having, for example, an index of variety equal to or larger than a threshold value, specifically, so that an entropy or a neuron coverage of the pieces of drift candidate data 61 are equal to or larger than a threshold value.

FIG. 6 shows an example in which three pieces of drift candidate data 61 are generated from one piece of non-drift data 42. As shown in FIG. 6, pieces of drift candidate data 61 are generated from the non-drift data 42 over the decision boundary 43 so as to have variance in the feature amount space. Thus, according to the example of FIG. 6, if there are 100 samples of the non-drift data 42, 300 samples of the drift candidate data 61 can be generated. As a matter of course, it is not necessary to generate pieces of drift candidate data 61 from all non-drift data sets 42 included in the non-drift data set, and pieces of drift candidate data 61 may be generated from a sub-set of a non-drift data 42 selected from the non-drift data set.

Next, a concept of processing for generating augmented data from the drift candidate data will be described with reference to FIG. 7.

FIG. 7 shows an arrangement of feature vectors in a feature amount space similar to that shown in FIG. 5. In addition to the feature vector 53 of the non-drift data set and the feature vector 54 of the drift data set, a feature vector 71 of drift candidate data 61 (a third feature vector) is shown.

The processing circuitry 10 calculates, by means of the calculation function 103, the feature vector 71 for each piece of drift candidate data 61. The feature vector 71 can be calculated in a method similar to that for calculating the feature vector 53 of the non-drift data set 51 and the feature vector 54 of the drift data set 52.

The processing circuitry 10 generates, by means of the generation function 104, augmented data from the drift candidate data based on the feature vectors 53, 54, and 71. Data that is selected as augmented data is drift candidate data that has a relevance to the feature amount of the drift data set and that does not have a relevance to the feature amount of the non-drift data set. This is because the augmented data is adapted to the actual drift data, or is prevented from continuously falling within the category of the non-drift data set and thus in fact belongs to the drift data set, since the decision boundary determined on the basis of a drift data set including a small number of pieces of data is an indefinite boundary.

The processing circuitry 10 generates, by means of the generation function 104, augmented data of a drift data set by selecting drift candidate data having a cosine similarity θ₁ between the feature vector 71 of the drift candidate data and the feature vector 54 of the drift data set of a threshold value or larger, and excluding, from the selected drift candidate data, drift candidate data having a cosine similarity θ₂ between the feature vector 71 of the drift candidate data and the feature vector 53 of the non-drift data set of the threshold value or larger. In other words, the processing circuitry 10 generates as augmented data, by means of the generation function 104, drift candidate data having a cosine similarity θ₁ equal to or larger than the threshold value and a cosine similarity θ₂ smaller than the threshold value. The number of pieces of generated augmented data is not limited, and may be increased or decreased in accordance with the design specification by adjusting, for example, the threshold value of a cosine similarity. For example, the number of pieces of generated augmented data is increased as the threshold value of the cosine similarity is decreased, and the number of pieces of generated augmented data is decreased as the threshold value of the cosine similarity is increased.

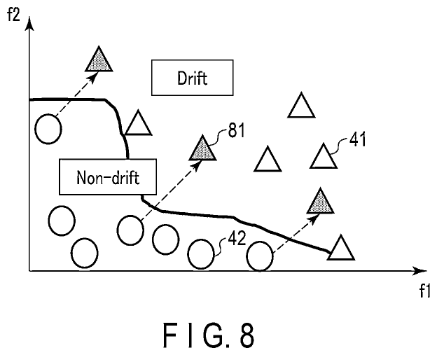

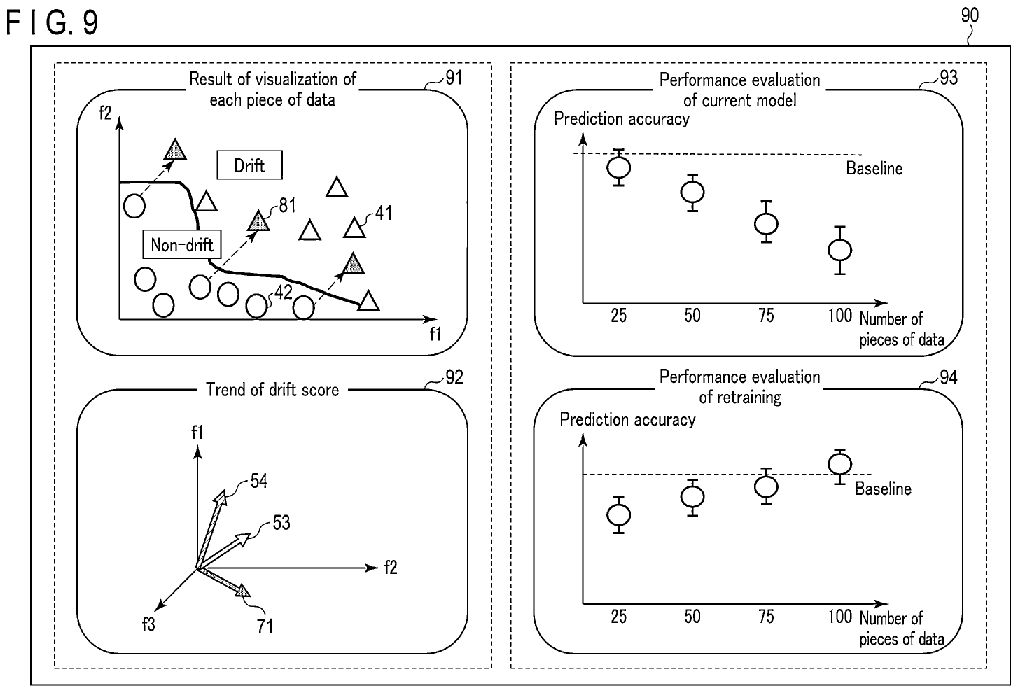

Next, an example of the distribution of the augmented data generated by the generation function 104 will be described with reference to FIG. 8.

FIG. 8, similarly to FIG. 4, shows a data distribution in a two-dimensional feature amount space according to the embodiment. As shown in FIG. 8, a plurality of pieces of augmented data 81 having a relevancy to the data trend of the drift data set are plotted. Thus, even in a stage where the number of pieces of data in the drift data set is small, the number of samples of the drift data set can be increased by generating a predetermined number of pieces of augmented data having a data trend different from that of the non-drift data set in consideration of the data trend of the drift data set.

Next, a display example of a trend of a drift score and a performance evaluation of a CDS model according to the present embodiment will be described with reference to FIG. 9.

FIG. 9 shows a display screen 90 showing a trend of a drift score and a performance evaluation of a CDS model, displayed on, for example, the display 14 or an external display connected to the network NW.

In the example of FIG. 9, the processing circuitry 10 performs, by means of the display control function 106, a control for displaying graphs relating to a data trend and a performance evaluation in four display regions.

A first display region 91 in an upper left part of FIG. 9 displays the plot diagram of FIG. 8 showing the data distribution of the non-drift data set, the drift data set, and the augmented data. A second display region 92 in a lower left part of FIG. 9 displays a graph of the feature amount space of FIG. 7 showing a trend of the drift score of each of the feature vectors.

A third display region 93 in an upper right part of FIG. 9 displays a performance evaluation of the current CDS model, executed by using a drift data set and augmented data. In the graph in the third display region 93, for example, the horizontal axis represents the number of pieces of data in a time sequence, and the vertical axis represents a prediction accuracy by the CDS model. In the graph shown in the third display region 93, the greater the number of pieces of data, the lower the prediction accuracy; thus, it is understood that the current CDS model is not adapted to the drift data set.

A fourth display region 94 in a lower right part of FIG. 9 displays a performance evaluation of a new CDS model obtained by retraining the CDS model. Also in the graph in the fourth display region 94, the horizontal axis represents the number of pieces of data in a time sequence, and the vertical axis represents a prediction accuracy. In the graph shown in the fourth display region, the greater the number of pieces of data, the more the prediction accuracy improved; thus, it is understood that the CDS model is adapted to the drift data set.

As described above, the user's determination and the model management can be assisted by displaying a data distribution of the non-drift data set, the drift data set, and the augmented data, a performance evaluation of the current model, and a performance evaluation of a model obtained after retraining. Specifically, it is possible to indicate an index of determination as to whether a drift data set has occurred, and if a drift data set has occurred, whether the current model should be retrained by using the drift data set to update the model.

In the example described above, a case where a drift data set is generated if data has drifted is assumed. However, the embodiment is not limited to this case. For example, the embodiment is applicable to a case where there are a plurality of data categories including a category in which only a small number of pieces of data have been acquired. For example, in a case where pieces of patient information on patients aged 60 and over have collected, while the number of pieces of patent information on patients aged under 30 is smaller, it is considered that the data trends of the two sets of information vary from each other. Therefore, by handling the patient information on patients aged 60 and over as a first data set and the patient information on patients aged under 30 as a second data set, processing can be executed in the same manner as handling of a non-drift data set and a drift data set. That is, according to the information processing apparatus 1 of the present embodiment, augmented data can be generated for not only drift data but also a small number of pieces of data having a data trend different from that of the other data.

According to the embodiment described above, a score indicating a degree of deviation of the data trend is calculated for a feature amount of each of the first data set and the second data set. A first feature vector of the first data set is calculated, and a second feature vector of the second data set having a data trend different from that of the first data set is calculated. Augmented data is generated from candidate data generated based on the first data set, based on the first feature vector and the second feature vector.

Specifically, if the first data set is a non-drift data set and the second data set is a drift data set, one or more pieces of drift candidate data are generated, using a model generated on the basis of the non-drift data set, based on the score output from the model. From among the pieces of drift candidate data, data that is not similar to the non-drift data set but similar to the drift data set is generated as augmented data. Thus, since the augmented data is based on the non-drift data set, realistic data can be generated as a drift data set, not an unrealistic drift data set. That is, a variety of augmented data that is realistic can be generated from a small number of pieces of data.

The term “processor” used in the above explanation means, for example, circuitry such as a central processing unit (CPU), a graphics processing unit (GPU), an application specific integrated circuit (ASIC), or a programmable logic device (for example, a simple programmable logic device (SPLD), a complex programmable logic device (CPLD), or a field programmable gate array (FPGA)).

If the processor is, for example, a CPU, the processor realizes its function by reading and executing the program stored in the storage circuitry. On the other hand, if the processor is, for example, an ASIC, the function corresponding to a program is directly incorporated into a circuit of the processor as a logic circuit, instead of being stored in the storage circuitry. The processors described in connection with the above embodiment are not limited to single-circuit processors; a plurality of independent circuits may be integrated into a single processor that realizes the functions. In addition, a plurality of structural elements shown in the drawings may be integrated into one processor to realize the functions of the structural elements.

Furthermore, the functions described in connection with the above embodiment may be implemented, for example, by installing a program for executing the processing in a computer, such as a workstation, etc., and expanding the program in a memory. The program that causes the computer to execute the processing can be stored and distributed by means of a storage medium, such as a magnetic disk (a hard disk, etc.), an optical disk (CD-ROM, DVD, etc.), and a semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus for applying to an artificial intelligence (AI) model, comprising processing circuitry configured to:
acquire a first data set having a first data trend and a second data set having a second data trend different from the first data trend, the first data set and the second data set being input to the AI model and discriminated by the AI model;
calculate a first feature vector based on the first data set and a second feature vector based on the second data set; and
generate augmented data having the second data trend based on the first feature vector and the second feature vector.

2. The information processing apparatus according to claim 1, wherein the second data set includes a smaller number of pieces of data than the first data set.

3. The information processing apparatus according to claim 1, wherein the processing circuitry is configured to:
generate one or more pieces of candidate data as candidates to belong to the second data set from the first data set; and
generate the augmented data from the candidate data based on the first feature vector, the second feature vector, and the candidate data.

4. The information processing apparatus according to claim 3, wherein the processing circuitry is configured to:
calculate third feature vector relating to each of the one or more pieces of candidate data; and
generate the augmented data by selecting one or more pieces of data that has a predetermined relevance between the first vector and the third vector from among the one or more pieces of candidate data, and excluding one or more pieces of data that has the predetermined relevance between the second vector and the third feature vector from the selected one or more pieces of data.

5. The information processing apparatus according to claim 1, wherein the processing circuitry is further configured to:
determine a decision boundary that classifies the first data set and the second data set; and
generate, from the first data set, one or more pieces of data as candidate data to be candidates to belong to the second data set over the decision boundary to the second data set, the one or more pieces of data having an index of variety of data equal to or larger than a threshold value.

6. The information processing apparatus according to claim 1, wherein the processing circuitry is further configured to evaluate, using the second data set and the augmented data, whether retraining of a trained model that has been trained with the first data set is necessary or not.

7. The information processing apparatus according to claim 1, wherein the processing circuitry is further configured to perform a control for displaying the first data set, the second data set, and a decision boundary that classifies the first data set and the second data set.

8. The information processing apparatus according to claim 1, wherein the processing circuitry is further configured to perform a control for displaying the first feature vector, the second feature vector, and a third feature vector relating to one or more pieces of candidate data as candidates to belong to the second data set.

9. The information processing apparatus according to claim 1, wherein the processing circuitry is further configured to perform a control for displaying, using the first data set and the augmented data, a performance evaluation of a trained model that has been trained with the first data set.

10. The information processing apparatus according to claim 1, wherein the processing circuitry is further configured to perform a control for displaying a performance evaluation of a retrained model that has been retrained with the first data set and the augmented data.

11. An information processing method for applying to an artificial intelligence model, comprising:
acquiring a first data set having a first data trend and a second data set having a second data trend different from the first data trend, the first data set and the second data set being input to the AI model and discriminated by the AI model;
calculating a first feature vector based on the first data set and a second feature vector based on the second data set; and
generating augmented data having the second data trend based on the first feature vector and the second feature vector.

12. A non-transitory computer readable medium including computer executable instructions, wherein the instructions, when executed by a processor, cause the processor to perform a method comprising:
acquiring a first data set having a first data trend and a second data set having a second data trend different from the first data trend, the first data set and the second data set being input to the AI model and discriminated by the AI model;
calculating a first feature vector based on the first data set and a second feature vector based on the second data set; and
generating augmented data having the second data trend based on the first feature vector and the second feature vector.
